(19) United States
(12) Patent Application Publication
(10) Pub. No.: US 2022/0098504 A1
(43) Pub. Date: Mar. 31, 2022

(54) PROCESS FOR USING SEQUESTERED CARBON DIOXIDE IN FUELS AND CHEMICALS

(71) Applicants: LARRY JACK MELNICHUK, South River (CA); KAREN SUE KELLY, Exeter (CA)

(72) Inventors: LARRY JACK MELNICHUK, South River (CA); KAREN SUE KELLY, Exeter (CA)

(21) Appl. No.: 17/487,083

(22) Filed: Sep. 28, 2021

Related U.S. Application Data
(63) Continuation of application No. 63/204,366, filed on Sep. 28, 2020.

(51) Int. Cl. C10L 3/08

(52) U.S. Cl. CPC C10L 3/08; C10L 2290/06; C10L 2290/10; C10L 2290/42

(57) ABSTRACT

A process to optimize carbon from carbon dioxide in synthesis gas used to produce synthetic chemicals and fuels. The process involves using captured carbon dioxide from any source and controlling its reformation with gaseous hydrocarbons to produce a synthesis gas with a specific carbon monoxide to hydrogen ratio suitable for selected intermediate and end products. The carbon from carbon dioxide displaces fossil carbon and lowers the carbon intensity of the products. The process uses any hydrocarbon gas, fossil or renewable, and may utilize steam to optimize the synthesis gas composition. The invention also includes recycling gases and the generation of heat, steam and electrical power for the reformer and other equipment, significantly reducing the carbon footprint of the plant.

### PRIORITY DATA

This patent application claims priority under 35 U.S.C. § 120 from U.S. Provisional Patent Application No. 63/204,366 filed Sep. 28, 2020 which is incorporated by reference herein for all purposes.

### TECHNICAL FIELD

The process herein provides a transitional production method of producing synthetic fuels and chemicals which bridges current production using entirely fossil fuels to entirely sustainable and renewable methods of the future. The present invention generally relates to a process which utilizes carbon dioxide captured from sources of emissions and reforms it with gaseous hydrocarbons to produce a synthesis gas comprising less fossil carbon, which then can be utilized as is or for many purposes. The synthesis gas, and hence the end product, will contain carbon donated from both the captured carbon dioxide and the gaseous hydrocarbon, therefore substituting carbon in the product which would normally be supplied entirely from fossil sources. Products include chemicals and fuels which can be made from synthesis gas. The process herein also provides a method of internal generation of power and steam, which significantly reduces the carbon footprint of the entire process, thereby further reducing the carbon intensity of all products.

### BACKGROUND ART

The efficient production of synthetic fuels and chemicals from synthesis gas produced from renewable sources is a challenge. Any current methods to produce such renewables are complex, expensive, and not yet widely commercial. As a result, there are few sources of renewable chemicals and fuels, which therefore contribute a very small percentage to markets. In a world where the atmospheric carbon pool is overloaded, renewable products and their manufacturing is not mitigating the problem. Instead, the atmospheric carbon pool continues to be increased by all our traditional manufacturing methods, all of which, on a global scale, involve using fossil fuels, i.e. crude oil, natural gas, or coal.

What is absent is a method by which partially-renewable (“semi-renewable) chemicals or fuels are produced from carbon dioxide as a co-feedstock, using modified traditional methods, by which the carbon contributed by the carbon dioxide is optimized according to the other co-feedstock(s) used. Semi-renewable chemicals or fuels are a valuable transitional step towards carbon emission reduction and would slow fossil carbon usage, giving an interim solution to the accelerating emissions which are being experienced today. Yet there are no available processes which are scalable, adaptable to the feedstock, and which could sequester large volumes of renewable carbon in the mega-volumes of fuels and chemicals which we consume daily. Further, there are no available processes which, in addition, utilize the internal generation of power and steam to reduce external energy requirements thereby reducing product carbon intensity and reducing the overall carbon footprint of the process.

There is considerable focus in research and development for methods to capture carbon dioxide, either from the atmosphere or from process emissions. Capture methods are now commercially available, and are becoming technically sophisticated. However, using all the captured carbon dioxide has become a global challenge—capture capacity far exceeds usage. Uses such as the production of carbon nanotubes, nanoparticles, and its use by microbes are novel solutions, but their production methods are technically difficult and economically challenging, with very limited end markets. Direct catalytic conversion of CO₂ to products is not yet commercial and most are at the experimental or early development level. Collecting the CO₂ in a pipeline to send to users for deep well extraction of oil is useful in some regions, but it is geographically restrictive. CO₂ continues to be useful in the food and beverage industry, where again location of supply and markets put limitations on the volumes used.

Use of captured CO₂ in the production of large volume chemicals and fuels would significantly reduce the rate of carbon atmospheric pool growth, and also displace the use of fossil carbon.

The starting point for making synthetic chemicals and fuels is the creation of a synthesis gas (“syngas”), which is a mixture of carbon monoxide and hydrogen. Syngas has been produced from coal since 1780, but today much production is from natural gas. Crude oil is not generally used to make synthesis gas. Syngas from natural gas is primarily used to produce methanol, the chemical starting point of the plastics industry, and an interim compound in the formation of gasoline-range hydrocarbons. Fischer-Tropsch fuels are also made from synthesis gas.

The use of renewable sources to produce syngas is particularly challenging. Any carbonaceous material, in particular biomass such as agricultural wastes, forest products, grasses, and other cellulosic material, including municipal waste streams known as refuse-derived fuel or solid waste fuel, may be converted to syngas. The most common methods are gasification, pyrolysis and hydro-treating, all of which produce syngas. However, the syngas typically comprises not only carbon monoxide and hydrogen, but may include carbon dioxide, carbon particles, methane and other light hydrocarbon gases, and in some cases, N₂, plus whatever other vaporized elements are present in the feedstock. The syngas must therefore typically be cleaned and conditioned before processing further. The efficient, economical and scalable production of clean, reaction-ready syngas is the foremost stumbling block in the production of renewable chemicals and fuels, and to date has prevented large scale, global, use.

In the alternative, captured carbon dioxide (“CO₂”) is a ready feedstock for reforming with gaseous hydrocarbons to produce a clean, substituted-carbon synthesis gas, i.e. the replacement of fossil carbon with carbon from the carbon dioxide. The syngas can then be used to produce substituted-carbon chemicals or fuels. Capture of CO₂ from any renewable process, such as production of renewable natural gas, anaerobic digestion or landfill gas supplies renewable carbon in the synthesis gas, not only displacing commensurate fossil carbon but also creating a semi-renewable end product. If the gaseous hydrocarbon with which the CO2 is reformed is also renewable, such as the methane from anaerobic digestion or from synthetic natural gas production, then all the carbon donated is neutral, bringing the carbon content of the end product to neutrality.

If the CO₂ is generated from fossil combustion or processing, capture and use of this carbon is a still a reduction of emissions to the atmosphere, and also displaces the use of new fossil carbon in the end product. Therefore, this carbon from the CO₂ feedstock provides an interim-sequestration of the otherwise-emitted fossil carbon. This carbon is, in fact, used for a second time because it is incorporated in a product and becomes an interim-sequestered carbon in the chemical or fuel typically produced from a pure fossil source. The recycle and use of any internally produced carbon dioxide also displaces fossil carbon. Any interim sequestration slows down the rate of fossil carbon emissions into the atmosphere, allowing more time for the update of carbon by local and global vegetation and bodies of water, helping to balance the atmospheric carbon pool.

The ideal situation is if the CO₂ is generated from renewable sources, the carbon contribution is truly neutral, rendering the end product semi-neutral as well. If the gaseous hydrocarbon with which the CO₂ is reformed is also renewable, such as the methane from anaerobic digestion or from synthetic natural gas production, the all the carbon donated is neutral, bringing the carbon content of the synthetic product chemical or fuel closer to total neutrality.

Production of synthesis gas using methane as a feedstock is typically done through steam reforming. The reactions are

CH₄+H₂O [symbol] CO+3H₂ Eq.1

CO+H₂O [symbol] CO₂+H₂ Eq.2

where some of the carbon monoxide reacts with the steam to form carbon dioxide and hydrogen, in equilibrium. Under typical conditions, therefore, carbon dioxide is a by-product of the synthesis gas production, wasting carbon.

Olah et al (U.S. Pat. No. 7,906,559) teaches that the addition of carbon dioxide as feedstock and a second catalyst to the reformer supplies the CO₂ in Eq.2 and therefore creates an equilibrium without the sacrifice of carbon monoxide. Olah et al (U.S. Pat. No. 8,980,961) further teaches that a specific ratio of methane, carbon dioxide and steam (water) optimizes the equilibrium and eliminates the carbon dioxide from the synthesis gas product. However, Olah et al do not teach the method by which adjustments can be made in the reformer to accommodate gaseous hydrocarbons other than methane, restricting his invention to the input ratios of pure methane, which does not occur in frequently in the practice because natural gas streams typically contain other gases, even following the removal of longer chain hydrocarbon gases (and sometimes carbon dioxide) from natural gas prior to market. Similarly Marker et al (U.S. Pat. No. 10,738,247) teaches that methane can be reacted with carbon dioxide to form a synthesis gas suitable for use in a Fischer-Tropsch (“F-T”) reactor to produce liquids, but does not teach control of the input streams to achieve an optimized synthesis gas containing the ratios of carbon monoxide and hydrogen which would produce maximum carbon yield from the F-T reactor. Although Marker refers to the use of other gaseous hydrocarbons in the input to the reformer, he does not teach the ability to accommodate the stoichiometric changes in the synthesis gas composition and its effect on the final F-T products. Herskowitz et al (U.S. Pat. No. 10,165,807) refers to the use of carbon dioxide, steam and methane in a reformer to produce a synthesis gas with a fixed carbon monoxide to hydrogen ratio without teaching control of the streams nor a method by which the ratio is maintained. No allowance if made to the input of other gaseous hydrocarbons or mixtures, in which event the composition of the synthesis gas would surely vary under his fixed conditions. Bae et al (EP 2,371,799) teaches similarly to Olah et al a method to produce methanol from synthesis gas prepared from methane, carbon dioxide and water (steam). Similarly to Olah, no provision is made for variations in composition of the input gaseous hydrocarbons, thereby providing a fixed reaction in which the composition of the synthesis gas may vary from the composition taught. The process is therefore not optimized and no provision is made to allow for future catalyst improvements which would move outside the boundaries for the fixed input ratios.

Reformers are being actively studied and new catalysts are being developed to provide improvements, and various organizations including universities, research institutes and catalyst manufacturers, are racing to find a the ideal catalyst to optimize and maximize the volume of carbon dioxide which can be reformed. The term “dry reforming” has been applied to this process, where the term “dry” refers to using carbon dioxide as a feedstock in the reformer.

It has been suggested that tri-reforming, which is a combination of steam reforming, “dry” reforming, and the addition of oxygen is an effective method to generate synthesis gas using carbon dioxide to reform methane. However, there appears to be no advantage to the addition of oxygen to accomplish the goals of reforming carbon dioxide. There may be an advantage in the future, especially for using dry reforming, but until the art has developed the combination of steam and dry reforming is the most practical and achievable.

### DISCLOSURE OF INVENTION

The instant invention teaches a novel method to utilize carbon dioxide in the production of a synthesis gas which has decreased fossil carbon but displaces the commensurate amount of fossil carbon content. In addition, the instant invention teaches the shrinking of the carbon footprint of the process through the generation of power by the use of heat generated by the reactor(s), enabling the production of steam. This internal use of energy significantly reduces or eliminates the need for external energy, thereby rendering the process climate friendly and enhancing the carbon index of the products.

The process first step is the acquisition of CO₂ from external sources such as: i) the capture of carbon dioxide from flue gas from any source, such as combustion of biomass or natural gas; ii) extraction from the atmosphere; iii) collection from anaerobic digestion or landfill; or iv) the import of gases from a dedicated captured carbon dioxide pipeline. CO₂ generated from subsequent catalytic steps also is recycled and used, thereby reducing potential carbon emissions. The method of collection of the CO₂ depends on the location of the facility and the volume required. Once collected the carbon dioxide may require cleaning to remove impurities present which would poison catalysts in the ensuing steps, and compression prior to reforming.

The next step in the process is the reforming of the carbon dioxide with gaseous hydrocarbons to produce a substituted-carbon synthesis gas. The gaseous hydrocarbons can be supplied from: i) a natural gas well; ii) a natural gas pipeline, prior to or after the extraction of natural gas liquids and carbon dioxide; iii) anaerobic digestion or landfill; or iv) from a process by which renewable natural gas is produced from biomass. The gaseous hydrocarbons may require cleaning to remove impurities which would poison the downstream catalysts, and compression to meet the reformer requirements.

The technical goal of the Reformer is to produce a synthesis gas which contains the maximum amount of carbon from the input carbon dioxide, and which also contains the optimum ratio of carbon monoxide to hydrogen (CO:H₂) to achieve the most efficient conversion to the selected end product of the process. This specific ratio of CO:H₂ in the synthesis gas is accomplished by controlling the inputs to the heated reformer, which operates under pressure and contains catalysts selected to produce it. The catalysts and the Reformer operate under equilibrium, and therefore the reactions are optimized by the injection of predetermined volumes of carbon dioxide, hydrocarbon gases, and steam. The stoichiometric ratios of the three input streams, together with the capabilities of the catalysts, will determine the composition of the syngas. The reactions are also controlled by the adjustment to specific volumes of steam fed to the reactor, which increases or decreases the volume of carbon monoxide produced.

It is therefore a requirement of the instant process that the composition of the gaseous hydrocarbons is known, to enable tight control of the CO₂ and steam input. The regulation of the input volumes requires looking beyond the production of the synthesis gas to the chemical composition and requirements of the product for which it is intended.

For example, in the production of methanol, the required theoretical ratio of CO:H₂ in the synthesis gas is 1:2. When CO₂ is injected into the reformer, this ratio will not naturally occur unless the volume is controlled. Further, the volume of CO₂ is limited by the upper limits of the catalyst reaction sites, and any excess will merely deposit as carbon on the catalyst and inhibit further reactions (coking). The volume of steam is therefore controlled to prevent any coking and force the reactions into equilibrium.

The resulting synthesis gas will then contain a proportion of carbon donated by the captured carbon dioxide, displacing the fossil (hydrocarbon) carbon, (hence the term “substituted carbon”) with the balance of carbon donated from the hydrocarbon. The substituted-carbon synthesis gas is thereby providing interim sequestration of the carbon which would have been emitted to the atmosphere had it not been captured.

Input hydrocarbon gases may contain a range of other compounds including but not limited to, methane (CH₄), ethane (C₂H₆), propane (C₃H₈), butanes (C₄H₁₀), pentanes (C₅H₁₂), hexane (C₆H₁₄), heptane (C₇H₁₆), sometimes trace amounts of octane (C₈H₁₈), olefins such as ethylene (C₂H₄), propylene (C₃H₆) and higher molecular weight hydrocarbons, nitrogen, hydrogen, carbon dioxide, and water. Any sulphur in the steam must be removed prior to processing as it poisons catalysts. The instant process provides for the use of any combination of gaseous hydrocarbons which may contain any, or all of the compounds listed.

Typically, gas Reformers using steam are endothermic with external heat sources required. The Technical Goal of the instant process is to utilize resident process steam for heating the Reformer, thereby reducing emissions which may have occurred from using external, fossil fuel sources. The waste heat from chemical reactions taking place in the process will generate internal electrical power and steam, both of which can be used in process operations, reducing or eliminating the need for external energy. The instant process utilizes a method by which the Reformer is operated in a controlled mode, using the injection of steam to compensate for the variations in input gas composition, and to selectively adjust the product synthesis gas ratio of carbon monoxide to hydrogen. The catalyst is selected to allow the maximum volume of carbon dioxide to be reformed, increasing the proportion of substituted carbon in the synthesis gas and end products.

The next step in the instant process is the conversion of the synthesis gas into the desired chemical or fuel. It is known in the art that synthesis gas can be readily converted into many chemicals and fuels. The instant invention provides a means by which the carbon from carbon dioxide can be sequestered in many practical products. The synthesis gas can be used, for example in a single Fischer-Tropsch reactor, and the CO:H₂ ratio can be adjusted as described depending on the catalyst used.

In one embodiment, the first reaction described herein is the conversion into methanol, which becomes either a product in itself, or the reactant for subsequent chemical conversion into fuels such as gasoline, jet fuel and diesel. Methanol is also the feedstock for many chemicals, such as acetic acid and its derivatives. In each case, the ratio of CO:H₂ and CO₂ in the synthesis gas created in the Reformer will reflect the parameters of the methanol reactor and of subsequent reactors employed to create the end product(s).

In another embodiment, the instant invention describes the conversion of the synthesis gas into dimethyl ether, which is also either used on its own or is a building block for further chemical conversion into fuels or chemicals. For example, to name just a few, it can be used as a fuel or converted to gasoline, olefins. The ratio of CO:H₂ in the synthesis gas created would be specific for the dimethyl ether but would be varied to meet the requirements of the end product.

### Technical Problem

The problem to be solved is threefold: a) to produce a synthesis gas composed of the maximum quantity of carbon donated from the carbon dioxide feedstock, and which also contains the optimum ratio of carbon monoxide to hydrogen to produce the desired chemical or fuel; b) to capture, recycle and incorporate any carbon emitted from the internal chemical, fuel, or heating production steps; and c) to reduce external energy (i.e. power) requirements by utilizing internal generation, thereby reducing the overall carbon footprint of the process.

This reduction of external energy requirements includes the use of process-generated steam, or if applicable, the use of steam donated from the carbon dioxide provider, to supply all or a portion of the process steam requirements. It will be appreciated by those skilled in the art that the recycling of unreacted gases for reprocessing also avoids unwanted process emissions. It will also be appreciated that capturing heat from chemical reactors is an excellent way to generate internal electrical power and steam which can then be utilized internally, thereby avoiding import of external, climate-expensive, energy and reducing the overall carbon footprint of the process.

### Solution to the Problem

The solution suggested is multi-faceted. a) The instant invention teaches the method by which technical parameters of a Reformer can be manipulated according to the chemical composition and characteristics of the input carbon dioxide and gaseous hydrocarbon streams to optimize the volume of carbon dioxide used and to produce the target synthesis gas with the CO:H2 ratio required for the desired end product; b) a method by which the carbon emissions from reactions can be recycled and incorporated into the process train; c) and the use of internally-generated power, or imported, steam or heat to reduce input energy (and associated carbon) requirements. All of these steps will reduce the carbon footprint of the instant process and create an end product which contains optimized substituted carbon.

### Advantageous Effects of Invention

The economics of renewable chemicals and fuels has always been measured against their counterparts produced from fossil sources. The fossil fuel and chemical industry have had many decades to establish functional, efficient and economic processes. Renewables, on the other hand, have not yet achieved that success. The instant invention bridges the gap between the established processes which utilize fossil carbon sources and those which use carbon from biomass. The instant invention utilizes conventional proven manufacturing equipment, but modifies their use by the incorporation of carbon dioxide as feedstock and manipulation of operations to favor the production of substituted carbon products. The instant invention is a transitional step to help decelerate the rate of emissions from the current volumes of production of the fossil chemicals and fuels on which we globally depend.

The instant invention will help improve the economic competitiveness of methods which diverge from the traditional, providing a transitional pathway to renewable chemical and fuel production.

The real benefit of the instant invention is the two-fold benefit to the environment by i) the reduction of carbon emissions through interim sequestration in products which would normally contain only fossil carbon; and ii) the reduction in the carbon footprint of the processing facility through the generation of power from excess heat in the process, and the generation of steam using that power, to reduce external energy requirements.

### BRIEF DESCRIPTION OF DRAWINGS

FIG. 1 is a description of the main feature of the instant invention, the creation of synthesis gas comprising substituted fossil carbon using carbon dioxide as a feedstock.

FIG. 2 is the preferred embodiment of a process to produce methanol and gasoline-range hydrocarbons from substituted-carbon synthesis gas, with internal energy generated and employed to reduce the external energy requirement.

FIG. 3 is an embodiment of a process to produce dimethyl ether and gasoline-range hydrocarbons from substituted-carbon synthesis gas, with internal energy generated and employed to reduce the external energy requirement.

### MODES FOR CARRYING OUT THE INVENTION

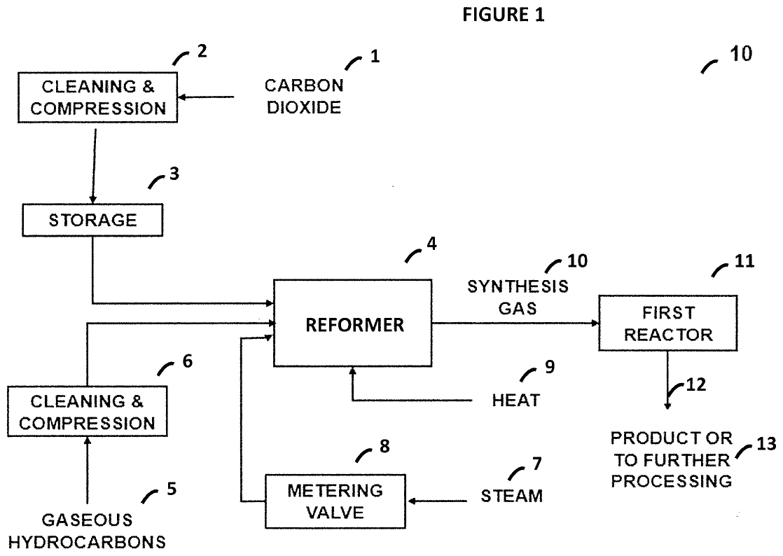

FIG. 1 at 10: Carbon dioxide at 1 is collected for the process. The source of the carbon dioxide determines the method by which it is collected. By way of example, flue gases containing carbon dioxide can be partially diverted into a collection system using state-of-the-art methods. Methods could include, but are not limited to, suctioning the flue gases and stripping them of the carbon dioxide using solvents, which may contain enzymes; forcing the flue gases through molecular sieves and collection of the filtered carbon dioxide; passing the flue gases over electrodes to attract and trap the carbon dioxide; or other methods which may become apparent. The captured carbon dioxide is then cleaned and compressed 2 to remove all contaminants which would poison the catalysts in the downstream reactions, and to meet the specifications required in the reforming reactor. Once cleaned and compressed, which will be specific to the carbon dioxide source, the cleaned, compressed carbon dioxide is then sent to storage 3 and maintained at the pressure required in the reformer. Storage is required if the supply of carbon dioxide is not continuous, or if the rate of collection does not match the rate at which the reformer operates. By way of example, no storage would be required if the carbon dioxide is acquired from a pipeline which provides a continuous supply. On the other hand, collection from flue gas may not acquire a consistent volume of carbon dioxide, and storage may therefore be required. The compressed, clean, carbon dioxide 3 is then fed into the Reformer 4 at a consistent measured rate and volume which maintains reaction equilibrium in the reformer, and which is in turn dependent upon the chemical composition of the gaseous hydrocarbon co-feedstock.

Gaseous hydrocarbons 5 are acquired. The gas or gases could include any or all of methane (CH₄), ethane (C₂H₆), propane (C₃H₈), butanes (C₄H₁₀), pentanes (C₅H₁₂), hexane (C₆H₁₄), heptane (C₇H₁₆), octane (C₈H₁₈), ethylene (C₂H₄), propylene (C₃H₆), and higher molecular weight hydrocarbons, nitrogen (N₂), hydrogen (H₂), carbon dioxide (CO₂), water (H₂O). and sulphur (SOX), trace rare gases such as argon (Ar), helium (He), neon (Ne), Xenon (Xe). The composition of the gaseous hydrocarbon stream will depend on its source. By way of examples, if the gaseous hydrocarbons are acquired from sources such as a pipeline or is synthetic (renewable) natural gas, it is generally almost pure methane and has been cleaned of contaminants. If acquired from other sources such as anaerobic digestion, natural gas wellhead, or a natural gas pipeline prior to cleaning, the gases must be then cleaned of all contaminants 6 which would poison the catalyst used in the reforming step which follows. This would include the removal of sulphur, which is particularly poisonous to catalysts. The cleaned gaseous hydrocarbons must then be compressed 6 to the pressure required by the Reformer 4. By way of example, compression may not be required for pipelined natural gas, which is already pressurized. In this case the gases are fed directly into the Reformer. In other cases, extensive cleaning of contaminants may be required, and one skilled in the art would select the appropriate methods to accomplish this.

A measured volume of the cleaned and compressed gaseous hydrocarbons 6 is fed continuously into the Reformer 4. The Reformer is a pressurized vessel with a catalyst and an external heat source 9. Steam 7 which has been pressurized to match the pressure required by the Reformer is measured by a metering valve 8 and sent to the Reformer 4. The volume of steam provided is selected to provide the optimum oxygen and hydrogen reagents to the chemical reactions which take place within the Reformer. The chemical reactions which take place are a combination of the typical reactions occurring in a steam methane reformer and reactions which involve methane and carbon dioxide in what is termed “dry reforming”. It will be apparent to those skilled in the art that the chemical composition of the gaseous hydrocarbons will dictate the volume of steam required to produce carbon monoxide from the carbon present. In illustration, if methane is present, the general equations for the reactions are:

CH₄+H₂O [symbol] CO+3H₂ Eq.3

CO+H₂O [symbol] CO₂+H₂ Eq.4

If, by way of example, propane is present, the general equations for the reactions are:

C₃H₈+3H₂O [symbol] 3CO+5H₂ Eq.3

3CO+3H₂O [symbol] 3CO₂+3H₂ Eq.4

It is evident that more steam must be added to provide for the reactions gaseous hydrocarbons other than methane are present in the input gases.

It will also be apparent to those skilled in the art that the volume of carbon dioxide 3 will be injected to provide equilibrium to the reactions without exceeding the optimum requirement in the first reactor 11.

The synthesis gas 10 produced in the Reformer contains carbon which is donated from the carbon dioxide as well as carbon from the gaseous hydrocarbon. This creates a synthesis gas which has a substituted fossil carbon, regardless of whether or not steam is added to the Reformer to produce the synthesis gas. The synthesis gas is then sent to the first reactor 11 to create a product 12 which may optionally be used to create further products 13.

It will be appreciated by those skilled in the art that there are a number of variables which may affect the actual application of the instant invention For this reason, it is necessary to analyze the composition of the input gaseous hydrocarbons and calculate the required volumes of steam and carbon dioxide to provide the optimum synthesis gas ratio for downstream reactions.

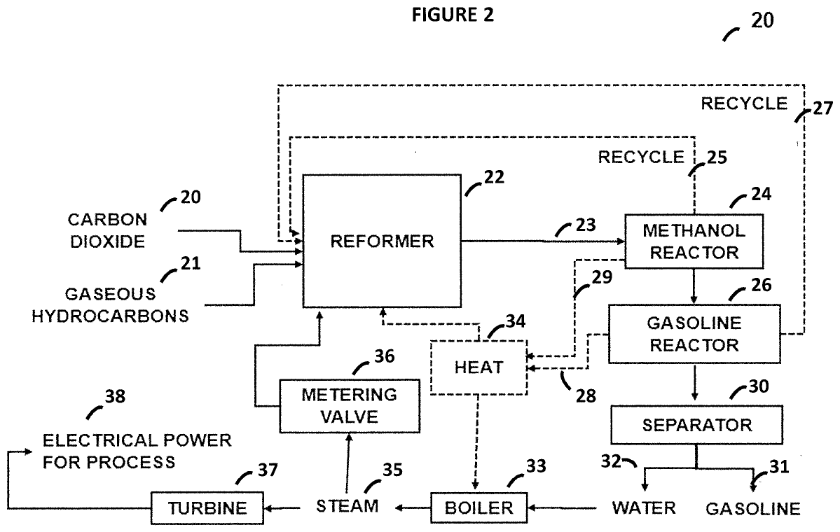

FIG. 2 at 20: In one embodiment gasoline-range hydrocarbons are produced through a methanol intermediate. Synthesis gas 23 is produced as in FIG. 1 by reacting a specific volume of cleaned, compressed carbon dioxide 20 with a specific volume of cleaned, compressed gaseous hydrocarbons 21, in the presence of a measured volume 34 of steam 33 in a heated, pressurized reformer 22 with a catalyst. The synthesis gas 23 produced comprises at least carbon monoxide, hydrogen and carbon dioxide, which, in this embodiment, provides an H₂:CO ratio of 2.05=(H₂+CO)/(CO₂+CO) suitable for the first reaction, which is the conversion of the synthesis gas into methanol in a methanol reactor 24.

It will be appreciated by those skilled in the art that there are a number of variables which may affect the actual application of the instant invention For this reason, it is necessary to analyze the composition of the input gaseous hydrocarbons and calculate the required volumes of steam and carbon dioxide to provide the optimum synthesis gas ratio for downstream reactions. 2. The volumes of carbon dioxide 20 fed to the Reformer 22 is adjusted according to the composition of the two recycle streams 25. 27 from the methanol reactor 24 and the gasoline reactor 26. Accordingly, the volume of steam required will also be adjusted through the metering valve 34 to maintain the inputs to the Reformer to achieve the 2.05 ratio. It will be evident to those skilled in the art that steady-state operations will be achieved through the use of process controls coupled with the results of on-stream sampling of the recycle gases, which enable the balancing of all inputs to the Reformer.

The synthesis gas enters the methanol reactor 24, a pressurized, thermally-controlled vessel containing a catalyst, where in an exothermic reaction it is converted to at least methanol. At least methanol is sent to the gasoline reactor 26, while the unreacted gases, which may contain at least CO, H₂, and CO₂, are recycled 25 back to the Reformer 22. The gasoline reactor 26 is a pressurized, thermally-controlled vessel containing a catalyst, which in exothermic reactions converts the at least methanol into at least gasoline-range hydrocarbons, at least light gaseous hydrocarbons, and water. The at least hydrocarbon gases 27 are recycled back to the Reformer 22 to be reprocessed. The gasoline-range hydrocarbons are sent to a separator 30 and separated 31 from water created during the reaction, and sent to storage. Separated water 32 is sent to a boiler 33. The boiler is heated using waste heat 34 provided by the methanol reactor 24 and the gasoline reactor 26, both of which are highly exothermic and from which the excess heat must be continually removed to protect their respective catalysts from sintering. A portion of the steam 35 created by the boiler 33 is then sent through the metering valve 36 to heat the Reformer. The unused portion of the steam is used in a turbine 37 to generate electrical power 38, which then may be used internally to power process equipment.

It will be evident to those skilled in the art that this embodiment can be implemented using different methanol or gasoline reactors, which will require specific inputs to achieve their products. The production of synthesis gas appropriate to these reactions will be achieved through the mechanism described herein to optimize the process with each reactor used.

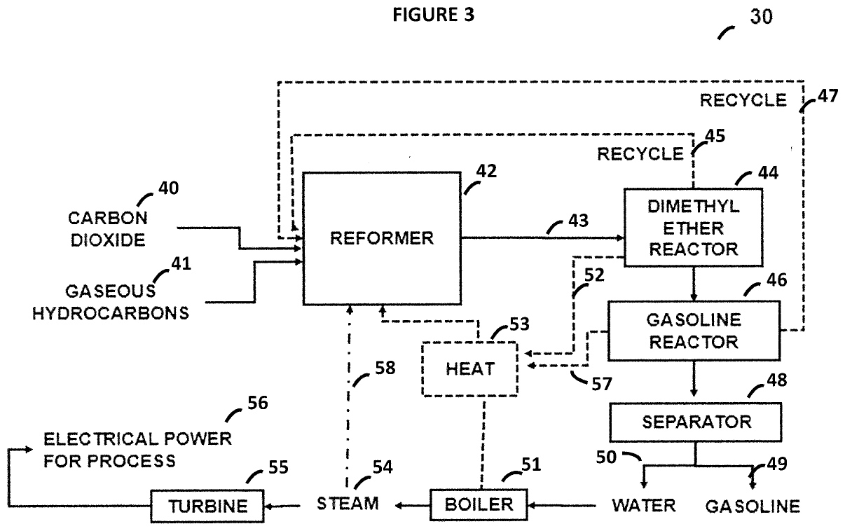

FIG. 3 at 30: In another embodiment gasoline-range hydrocarbons are produced through a dimethyl ether intermediate. Synthesis gas 43 is produced as in FIG. 1 by reacting a specific volume of cleaned, compressed carbon dioxide 40 with a specific volume of cleaned, compressed gaseous hydrocarbons 41 in a heated, pressurized reformer 42 with a catalyst. The synthesis gas 43 produced comprises at least carbon monoxide, hydrogen and carbon dioxide, which, in this embodiment, provides an H₂:CO ratio of 1:1.1=(H₂+CO)/(CO₂+CO) suitable for the first reaction, which is the conversion of the synthesis gas into dimethyl ether. The volumes of carbon dioxide 40 fed to the Reformer 42 is adjusted according to the composition of the two recycle streams 45, 47 from the dimethyl ether reactor 44 and the gasoline reactor 46. It will be evident to those skilled in the art that steady-state operations will be achieved through the use of process controls coupled with the results of on-stream sampling of the recycle gases, which enable the balancing of all inputs to the Reformer.

The synthesis gas enters the dimethyl ether reactor 44, a pressurized, thermally-controlled vessel containing a catalyst, where in an exothermic reaction it is converted to at least dimethyl ether. At least dimethyl ether is sent to the gasoline reactor 46, while the unreacted gases, which may contain at least CO, H₂, and CO₂, are recycled 45 back to the Reformer 42. The gasoline reactor 46 is a pressurized, thermally-controlled vessel containing a catalyst, which in exothermic reactions converts the at least dimethyl ether into at least gasoline-range hydrocarbons, at least light gaseous hydrocarbons, and water. The at least light gaseous hydrocarbons 47 are recycled back to the Reformer 42 to be reprocessed. The gasoline-range hydrocarbons and water formed in the reaction are sent to a separator 48 and separated from the water It will be appreciated by those skilled in the art that there are a number of variables which may affect the actual application of the instant invention For this reason, it is necessary to analyze the composition of the input gaseous hydrocarbons and calculate the required volumes of steam and carbon dioxide to provide the optimum synthesis gas ratio for downstream reactions 49, and sent to storage. Water 50 is sent to a boiler 51. The boiler is heated using waste heat 53 provided 52, 57 by the dimethyl ether reactor 44 and the gasoline reactor 46, both of which are highly exothermic and from which the excess heat must be continually removed to protect their respective catalysts from sintering. The steam 54 is used in a turbine 55 to generate electrical power 56, which then may be used internally to power the pumps and other components of the process equipment. If the Reformer 42 is found to coke from excess carbon deposition formed during the synthesis gas reactions, then steam 58 can be used to produce additional carbon monoxide. This will affect the synthesis gas composition, which will then require adjustment through the mechanisms described herein.

It will be evident to those skilled in the art that this embodiment can be implemented using different dimethyl ether or gasoline reactors, which will require specific inputs to achieve their products. The production of synthesis gas appropriate to these reactions will be achieved through the mechanism described to optimize the process with those variations.

It will be evident to those skilled in the art that there are many variations of the instant process which will accomplish the technical goals of utilizing carbon dioxide as a feedstock together with gaseous hydrocarbons and reforming them into a synthesis gas suitable for downstream reactions. It will be evident that the adjustment of the input ratios to the reformer will allow a variation in the composition of the synthesis gas, and therefore allow for the production of many end products. Because almost all chemical reactions will be exothermic, the principles described herein will be applicable to each embodiment utilized, and produced water, if any, will be able to be used to produce steam for generating electrical power and for modulating the reactions in the reformer.

In the instant invention, the use of steam or electrical power from a host facility, which may supply the carbon dioxide and/or the gaseous hydrocarbons, will also enable a similar opportunity to shrink the carbon footprint of the plant. The use of host energy is therefore included by reference in the description herein.

### INDUSTRIAL APPLICABILITY

The instant invention has valuable industrial applicability to any process which is emitting carbon dioxide to the atmosphere and desires to reduce them. Capture of all or part of the carbon dioxide is beneficial by reducing the atmospheric carbon pool, and the interim sequestration of that carbon in a chemical or fuel successfully displaces carbon from a fossil source. Overall reduction of fossil carbon in products is a transition to the time when a permanent and more extensive solution can be found. There are a vast number of industrial production facilities globally which could provide carbon dioxide. The volumes which could be sequestered in consumable products is incalculable. In addition, the use of recycling and generation of internal process energy reduces the carbon footprint of the facility, which provides a means by which emitters can diversity their operations and participate in rewarding and environmentally beneficial processes.

The instant invention also has carbon-saving applicability to established plants which may be generating excess steam or energy in their facility. The bolt-on ability of the instant invention to an existing facility which is not only emitting volumes of carbon dioxide, but also has excess energy and steam, provides a means by which those facilities can shrink their own carbon footprint. This ability in the very near future may mean the difference between maintaining operations or being forced to close.

What is claimed is:

1. A process to produce a synthesis gas comprising at least carbon from carbon dioxide:
a. extracting and collecting gases containing at least carbon dioxide from a source;
b. cleaning the gases containing at least carbon dioxide of impurities if required in downstream process operations;
c. pressuring the gases containing at least carbon dioxide and feeding to a heated pressurized catalytic reactor;
d. cleaning a gas stream containing at least gaseous hydrocarbons of impurities if required in downstream process operations;
e. pressurizing the gas stream containing at least gaseous hydrocarbons if required and feeding to the heated pressurized catalytic reactor;
f. adding a calculated volume of steam to the reactor such as to promote the reactions to produce a synthesis gas containing at least carbon monoxide and hydrogen in a ratio which favors the production of an end product;
g. feeding the formed synthesis gas containing at least the desired ratio of carbon monoxide to hydrogen to a reactor or series of reactors to produce an end product comprising at least carbon from the input carbon dioxide.

2. A process to produce a synthesis gas comprising at least carbon from carbon dioxide as in claim 1 where the input gases containing at least carbon dioxide have been captured from flue gas emitted by a process which uses biomass, fossil fuel or flare gas;

3. A process to produce a synthesis gas comprising at least carbon from carbon dioxide as in claim 1 where the gases containing at least carbon dioxide are produced by anaerobic digestion or fermentation;

4. A process to produce a synthesis gas comprising at least carbon from carbon dioxide as in claim 1 where the gases containing at least carbon dioxide are captured from a synthesis process;

5. A process to produce a synthesis gas comprising at least carbon from carbon dioxide as in claim 1 where the gases containing at least carbon dioxide or gaseous hydrocarbons are recycled from any step in the process;

6. A process to produce a synthesis gas comprising at least carbon from carbon dioxide as in claim 1 where the gases containing at least gaseous hydrocarbons are provided directly from a gas well or from a pipeline;

7. A process to produce a synthesis gas comprising at least carbon from carbon dioxide as in claim 1 where the gases containing at least gaseous hydrocarbons are contained in the emissions from anaerobic digestion or fermentation.

8. A process to produce a synthesis gas comprising at least carbon from carbon dioxide as in claim 1 where the gases containing at least gaseous hydrocarbons is synthetic natural gas produced from biomass or coal.

9. A process to produce a synthesis gas comprising at least carbon from carbon dioxide as in claim 1 where the optimum carbon monoxide to hydrogen ratio of 0.5-3.0 for step g is achieved from the controlled volume of carbon dioxide relative to the carbon composition of the gaseous hydrocarbons and the volume of steam required to eliminate coking and maintain reaction kinetic equilibrium.

10. A process to produce a synthesis gas comprising at least carbon from carbon dioxide as in claim 1 whereas the reactor in step c. operates at a temperature range of 800° C. to 1000° C. and preferably at 875° C. and a pressure of 0.1-5 MPa, preferably at 0.1 MPa.

11. A process to produce a synthesis gas comprising at least carbon from carbon dioxide as in claim 1 whereas steam is fed into the reactor at a temperature range of 210° C. to 225° C. and preferably 215° C. and at a pressure of 1.5 MPa to 2.0 MPa and preferably at 1.9 MPa.

12. A process to produce a synthesis gas comprising at least carbon from carbon dioxide as in claim 1 step g where the first reactor produces methanol or a mixture of methanol and dimethyl ether comprising at least carbon from carbon dioxide and the second reactor produces gasoline-range hydrocarbons comprising at least carbon from carbon dioxide.

13. A process to produce a synthesis gas comprising at least carbon from carbon dioxide as in claim 1 step g where the first reactor produces a mixture of methanol and dimethyl ether comprising at least carbon from carbon dioxide which is separated into methanol and dimethyl ether, the methanol is converted in a second reactor to olefins, and the dimethyl ether is converted in a third reactor into hydrocarbons and aromatics and the olefins, hydrocarbons and aromatics are blended into jet fuel comprising at least carbon from carbon dioxide.

14. A process to produce a synthesis gas comprising at least carbon from carbon dioxide as in claim 1 step g where the first reactor produces methanol or a mixture of methanol and dimethyl ether, comprising at least carbon from carbon dioxide and the next reactions are chosen to produce at least acetic acid and its derivatives comprising at least carbon from carbon dioxide.

15. A process to produce gasoline-range hydrocarbons comprising at least carbon from carbon dioxide as in claims 12, 13 and 14 where the unconverted gases from the chemical reactors is recycled back to the reformer.

16. A process to produce gasoline-range hydrocarbons comprising at least carbon from carbon dioxide as in claims 12, 13, and 14 where the heat from the reactors is captured to produce steam and electricity for use in the reformer and process equipment.

17. A process to produce a synthesis gas comprising at least carbon from carbon dioxide as in claim 1 where step f is not required and where as in step g the first reactor produces dimethyl ether comprising at least carbon from carbon dioxide and the second reactor produces gasoline-range hydrocarbons comprising at least carbon from carbon dioxide.

18. A process to produce a synthesis gas comprising at least carbon from carbon dioxide as in claim 1 where as in step g. there is only one reactor which is a Fischer-Tropsch reactor.
